(19) United States
(12) Patent Application Publication
(10) Pub. No.: US 2012/0011821 A1
(43) Pub. Date: Jan. 19, 2012

(54) Variable Speed Lean Bar

(75) Inventors: Brian D. Olander, Buhler, KS (US); Martin E. Pruitt, Hesston, KS (US)

(73) Assignee: AGCO CORPORATION, Duluth, GA (US)

(21) Appl. No.: 13/185,757

(22) Filed: Jul. 19, 2011

Related U.S. Application Data
(60) Provisional application No. 61/365,471, filed on Jul. 19, 2010.
(60) Provisional application No. 61/365,468, filed on Jul. 19, 2010.
(60) Provisional application No. 61/365,463, filed on Jul. 19, 2010.

(30) Foreign Application Priority Data
Jul. 19, 2011 (US) PCT/US11/44526

(51) Int. Cl. A01D 34/00

(52) U.S. Cl. 56/17.3

(57) ABSTRACT

In an example embodiment a header includes a rotatable lean bar. A controller may be provided to manipulate the rotation of the lean bar. In an example embodiment, rotation of the lean bar may be manipulated in response to a characteristic of a vehicle, such as vehicle speed. In one example embodiment a control panel is provided in a cab of a vehicle to allow an operator to manipulate rotation of the lean bar. A sensor may be provided to detect characteristics of the rotation and a display provided to indicate rotational characteristics of the lean bar.

### CROSS REFERENCE TO RELATED APPLICATIONS

This application claims priority to co-pending U.S. Provisional Application No. 61/365,471 filed Jul. 19, 2010, entitled “VARIABLE SPEED LEAN BAR” (P1135H); U.S. Provisional Application No. 61/365,468 filed Jul. 19, 2010, entitled “HEADER WITH IMPROVED LEAN BAR” (P1134H); and U.S. Provisional Application No. 61/365,463 filed Jul. 19, 2010, entitled “HEADER WITH ADJUSTABLE LEAN BAR” (P0904H), which all are entirely incorporated herein by reference. The present U.S. Nonprovisional Application is related to U.S. Nonprovisional Application entitled “HEADER WITH IMPROVED LEAN BAR” (A1134H), and U.S. Nonprovisional Application entitled “HEADER WITH ADJUSTABLE LEAN BAR” (A0904H), which are both incorporated herein by reference in their entirety, having been filed concurrently with the present application.

### FIELD OF THE INVENTION

The present invention relates generally to crop harvesting equipment. More particularly, the present invention concerns a mower/conditioner having structure for directing crop material into the proper orientation for feeding and cutoff.

### BACKGROUND

Lean bars, also known as knock-down bars, may be used to knock down crop material for cutoff and feeding into a header. For example, lean bars may be used to knock down the top end of high biomass crop material for proper feeding into a header which cuts and conditions the crop material and deposits conditioned crop material into a swath or windrow.

### BRIEF DESCRIPTION OF THE DRAWING FIGURES

FIG. 1 shows a perspective view of an example embodiment of a self-propelled windrower that may employ a lean bar in accordance with the present invention.

FIG. 2 shows a left side view of the windrower of FIG. 1.

FIG. 3 shows a front view of the windrower of FIG. 1.

FIG. 4A shows an example embodiment of a header assembly having a freely rotating lean bar.

FIG. 4B shows an example embodiment of a header assembly having a powered lean bar.

FIG. 4C shows an enlarged view of a portion of FIG. 4B.

FIG. 5A shows a front view of the header assembly of FIG. 4B.

FIG. 5B shows a cutaway view of the header assembly of FIG. 5A.

FIG. 6 shows a left side cutaway view of an example embodiment of a header arrangement.

FIG. 7A shows a left side view of an example embodiment of a header assembly having a lean bar in a first position.

FIG. 7B shows the header assembly of FIG. 7A with the lean bar in a second position.

FIG. 8A shows a right side view of an example embodiment of a header assembly having a powered lean bar in a first position.

FIG. 8B shows the header assembly of FIG. 8A with the lean bar in a second position.

FIG. 9 shows a system diagram for controlling a lean bar in accordance with an example embodiment of the invention.

FIG. 10 shows a control panel for controlling a header assembly in accordance with an example embodiment of the invention.

### OVERVIEW

In an example embodiment, a header assembly includes a header configured to process crop material and a lean bar assembly having a lean bar as the leading element for contacting crop material and preparing the crop material for processing by the header. In an example embodiment, the lean bar assembly may include a rotatable lean bar configured to engage crop material and urge it in a desired direction. The lean bar assembly may include a rotatable lean bar having a laterally extending member coupled to positioning arms extending forward of the header so that the lean bar is positioned as the leading contact member of the header assembly. The lean bar may be configured for rotation about the axis of the lean bar member.

In addition to knocking down crop material by the contact of a surface of the laterally extending member with the crop material, the lean bar may be provided with various crop manipulation features, such as auger flights, fingers, paddles, flutes, and the like, to urge the crop material in a desired direction for processing by the header. The header assembly may thus be arranged so that the lean bar not only knocks down crop material but urges it in a desired direction to the header for cutting, conditioning, and discharge into a windrow.

In one example embodiment, a rotatable lean bar may configured for free rotation so that the engagement of the crop material by the lean bar assists in rotating the lean bar, thereby improving the lean bars ability to manipulate the crop material. In one example embodiment, the lean bar may be journaled in bearings provided on positioning arms to allow the lean bar to freely rotate. The lean bar may be provided with rotation urging elements that are configured to engage the crop material and assist in rotating the lean bar. Thus, contact of the lean bar with the crop material assists the rotation of the lean bar which in turn improves the ability of the lean bar to manipulate the crop material.

The lean bar may be provided with crop urging elements to urge the crop material in a desired direction. For example, auger fighting or other elements may be provided to urge the crop material laterally inward toward conditioning rolls of the header. It should be noted that a particular element of the lean bar may serve to rotate the lean bar and urge the crop material in a desired direction.

The lean bar may be configured for powered rotation. In one example embodiment, a variable speed reversible hydraulic motor is provided to power the rotation of the lean bar. A controller may be used to manipulate the motor and vary the rotational speed and direction of the lean bar in accordance with a predetermined scheme. For example, the controller may be used to rotate the lean bar in a first direction or a second direction, and/or rotate the lean bar at a constant speed or at a variable speed, etc. In addition, the controller may be configured for operation in a variety of modes which allow the operator different levels of control over the operation of the lean bar. For example, the controller may be operable in a manual mode in which an operator directly controls the rotation of the lean bar by an input means or an automatic mode in which the controller manages the operation of the lean bar in accordance with a predetermined scheme with minimal operator input. To assist the operator in manipulating the lean bar, a control system may be provided that includes a control panel accessible by the operator, such as within the cab of a vehicle, to allow the operator to change various modes of the controller and manipulate the rotation of the lean bar as desired. The motor could b configured to provide a fixed speed.

The lean bar assembly may be configured so that its position is adjustable to allow the lean bar to be placed in an optimal position for processing a particular crop material. For example, the lean bar may be configured for manual adjustment by the movement of positioning arms that support the lean bar. In one example embodiment, a slot/pin type arrangement is configured to allow for the translational and rotational movement of the positioning arms with respect to the header.

The lean bar may also be configured for remote adjustment by an operator. For example, in one embodiment a lean bar adjustment system comprises a hydraulic piston and solenoid arrangement configured to move the positioning arms. A control panel may be provided to an operator, such as in a cab of the vehicle, to allow the operator to manipulate the arrangement and thereby change the position of the lean bar from the cab of the vehicle.

### DESCRIPTION OF EXAMPLE EMBODIMENTS

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which exemplary embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, while the example embodiments are discussed in the context of a lean bar with a rotary header, it will be understood that the present invention is not so limited and that other type headers, such as sickle headers, may be used, and that it may be used in conjunction with a variety of agricultural vehicles.

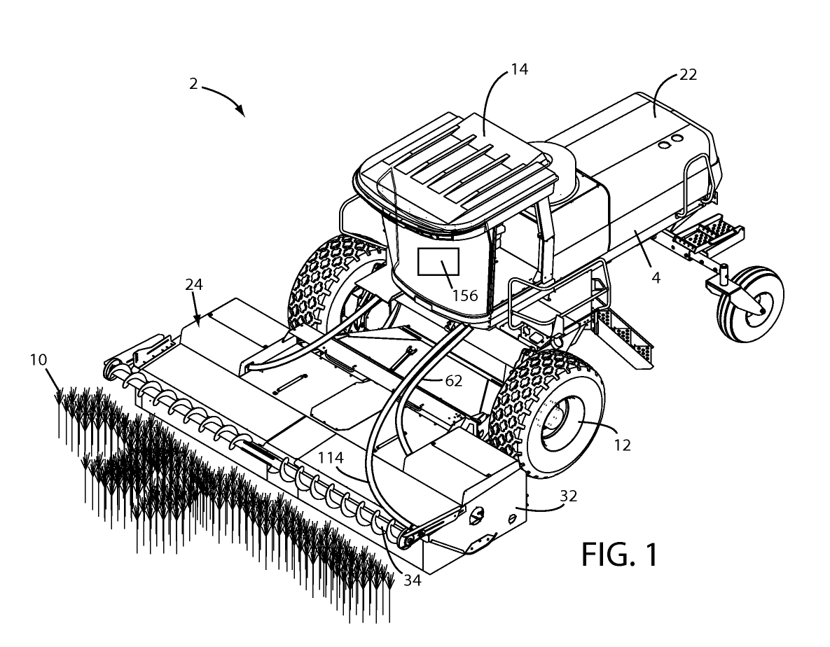

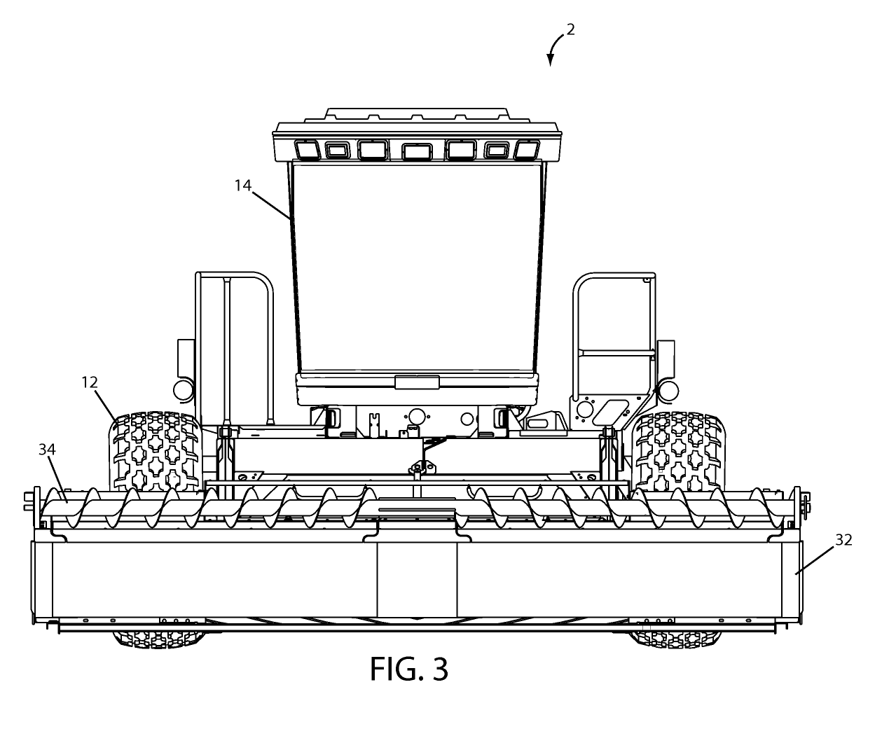

Turning to the Figures, FIGS. 1-3 show a harvester in the form of a self-propelled windrower 2 operable to process crop material, such as knocking down, cutting and collecting standing crop 10 in the field, conditioning the cut material, and discharging the conditioned material in a windrow or swath. The windrower 2 may include a chassis or frame 4 supported by wheels 12 for movement across a field to be harvested. The frame 4 may carry a cab 14, within which an operator controls operation of the windrower 2, and a rearwardly spaced compai talent 22 housing a power source (not shown) such as an internal combustion engine.

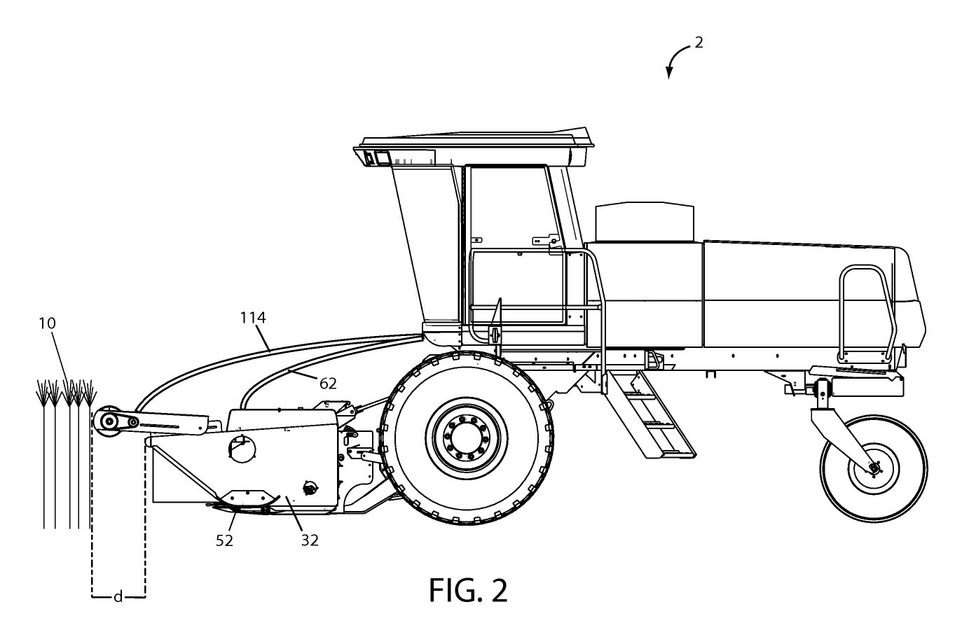

A harvesting header assembly 24 may be supported on the front of the frame 4 and include a header 32 and a lean bar 36 including a lean bar 34 configured to knock down crop material 10. As perhaps best seen in FIG. 2, the lean bar 34 may be positioned a distance d forward of the header 32 so that the lean bar 34 is the forward-most, or leading, element of the header assembly 24. The lean bar 34 is configured to knock down crop material for processing by the header 32. For example, the lean bar may engage the top end of crop material as the header assembly 24 moves through the field.

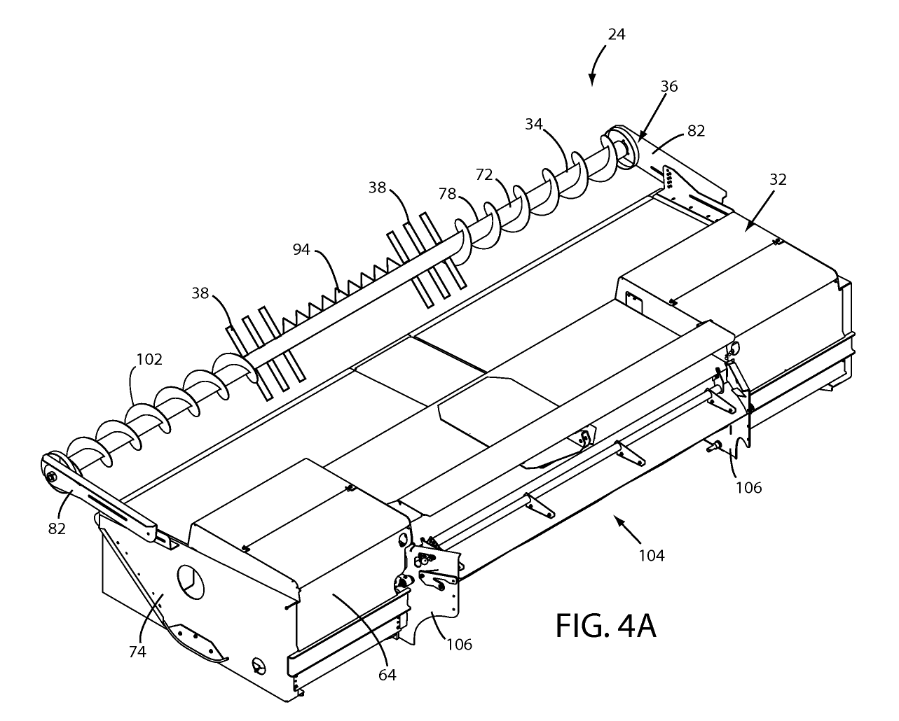

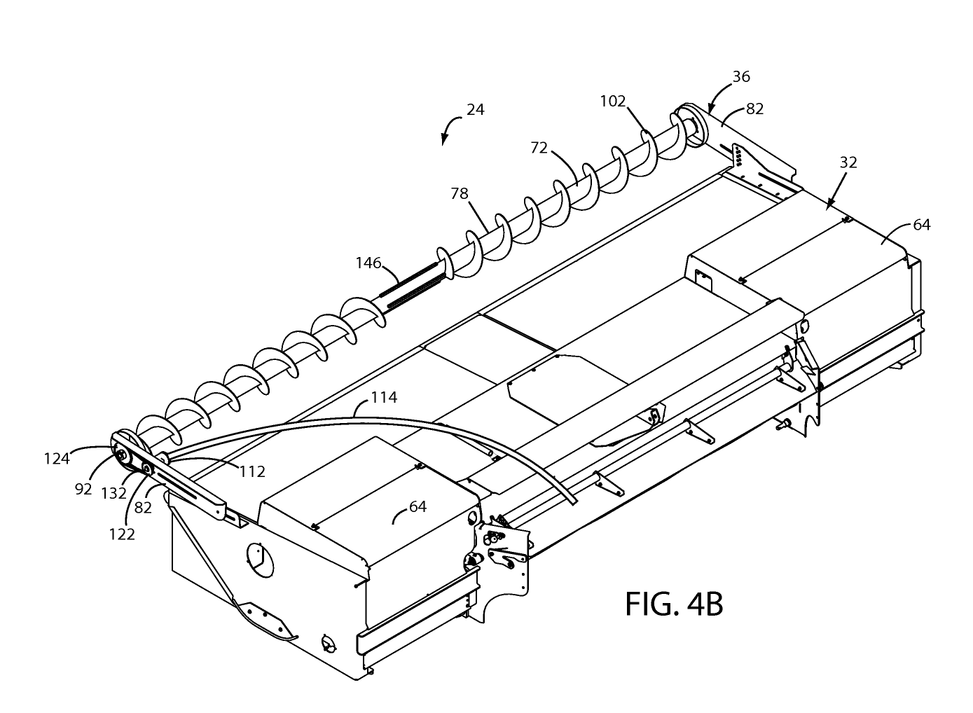

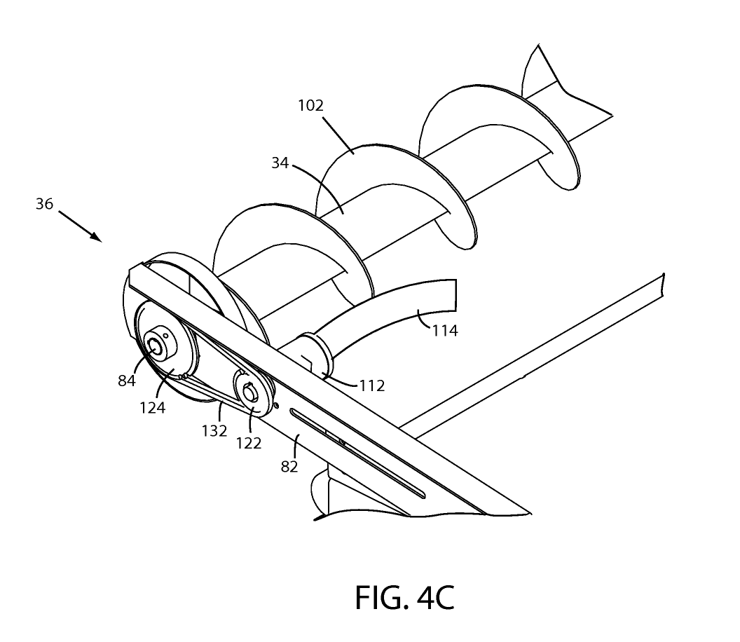

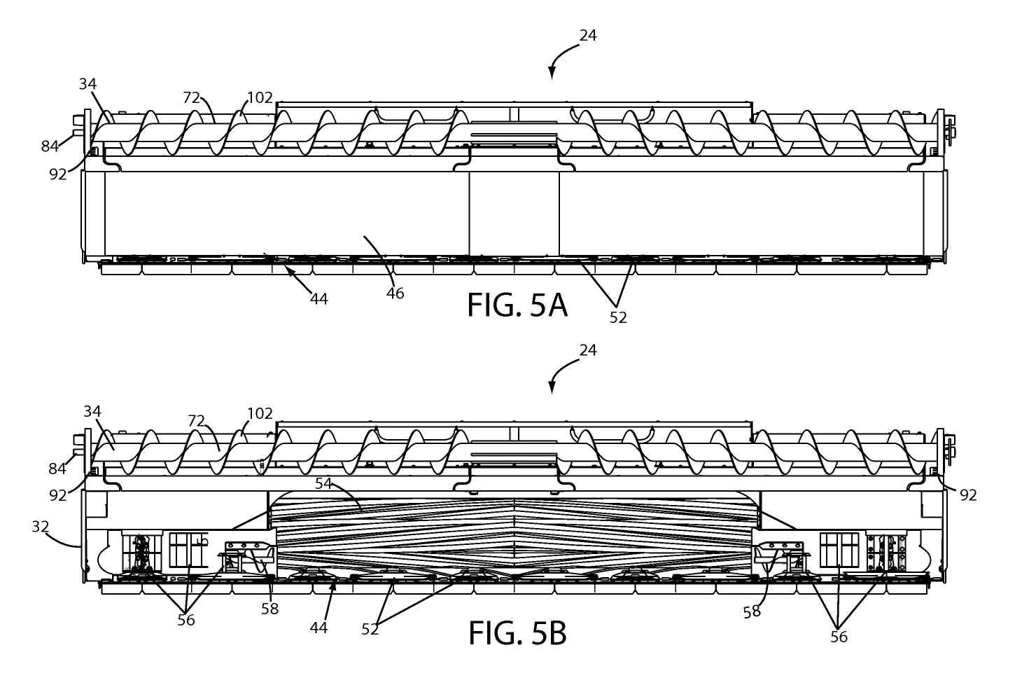

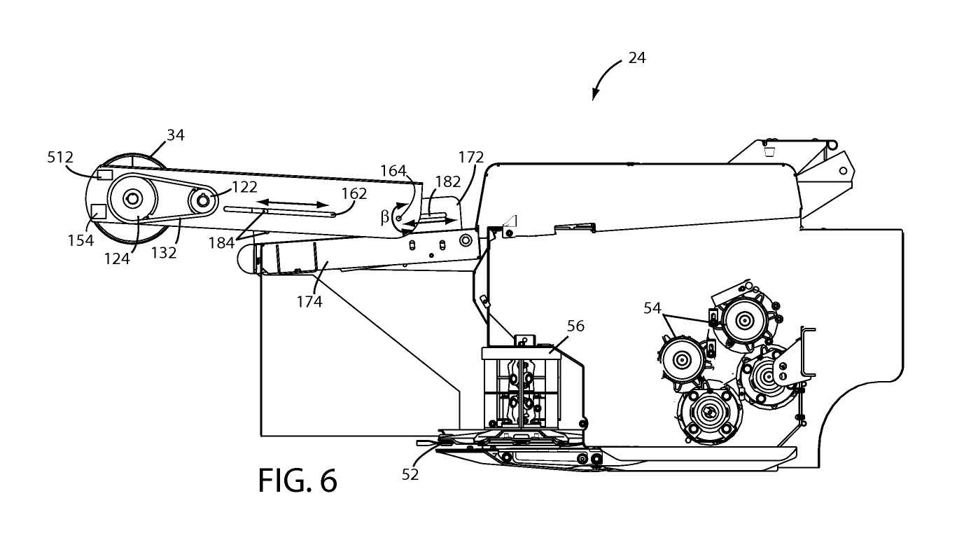

As seen in FIGS. 4A-7, the header 32 may be configured to cut, condition, and discharge crop material into a windrow. The particular arrangement of the header 32 may be similar to that disclosed in U.S. Pat. No. 6,158,201 to Pruitt et al. entitled “Rotary Mower Conditioner Having Improved Crop Flow” and U.S. patent application Ser. No. 12/353,831 entitled “Wide Cut Rotary Harvester Having Crop Feeding Mechanism” both of which are assigned to the assignee of the present invention and both of which are incorporated by reference in their entirety herein. The header 32 may include a cutting bed 44 that includes a plurality of cutters 52 for cutting crop material and conditioning rolls 54 (FIGS. 5B and 6) for conditioning the cut material. As seen in FIG. 5A panels 46 may cover a front portion of the header.

The header 32 may be powered by hydraulic lines 62 (FIGS. 1 and 2) extending from the vehicle 10 to hydraulic motors (not shown) housed within motor housings 64. The motors may power the cutters 52 of the cutting bed 44 by a gear arrangement or other means. The conditioning rolls 54 may be laterally narrower than the cutoff width of the cutting bed 44 so that it may be desirable to urge crop material laterally inward for conditioning by the conditioning rolls. Impeller cages 56 and stub augers 58 may be used to move crop material towards conditioning rolls 54 for conditioning.

In the example embodiment shown in FIGS. 1-3, the lean bar 34 may comprise a generally cylindrically-shaped transversely-extending member 72, shown in the example embodiment as a hollow tube. The outer surface 78 of the member 72 is configured to contact and knock down crop material 10. The member 72 may be coupled to the header frame 74 by a pair of adjustable positioning arms 82. As seen in the example embodiment, the positioning arms 82 are arranged such that the lean bar 34 is positioned as the leading element in the arrangement.

The lean bar 34 may be rotatably mounted to the positioning arms 82. For example, shaft ends 84 of the member 72 may be journaled for rotation at the positioning arms 82 by bearing assemblies 92. The rotation of the lean bar 34 assists in urging the crop material in a desired direction, such as rearward toward the header 32.

In the example embodiment shown in FIG. 4A the lean bar 34 may be mounted for free rotation as the leading element in the header assembly 24 so that as the header 32 moves through the field, the lean bar 34 contacts the crop material resulting in the rotation of the lean bar 34. Rotation assisting elements may be provided at the lean bar 34 to further engage the crop material 10 and assist in lean bar rotation. For example, fingers, feeding bars, paddles, and the like, may extend radially from the transverse member 72 so as to engage crop material 10 passing under the lean bar 34 and more effectively rotate the lean bar 34 as the bar 34 pushes the crop material 10 downward. In one example embodiment, the fingers may have a length of about 3 inches and a diameter/width of about 0.5 inches. In the example embodiment shown in FIG. 4A teeth 94 also be provided to engage the crop material and assist in lean bar rotation. The teeth may be cut from a steel plate ⅛″ thick and have a sawtooth arrangement with a point about every 2 inches.

The lean bar 34 may also be provided with crop urging elements configured to urge crop material in a desired direction. In the example embodiment of FIG. 4A, auger flights 102 are arranged at the outer lateral portion of the lean bar 34 so as to urge crop material laterally inward toward the conditioning rolls 54 of the header 32. This rotation of the lean bar 34, either by the contact of the lean bar with the crop material or otherwise driven, allows the auger flights 102 to assist in urging the crop material toward the conditioning rolls 54 of the header 26. In addition or in lieu of the auger flights 102, disks or other urging elements could be used. In the example embodiment shown in FIG. 4B the lean bar 34 also includes fluting 146 at the center of the lean bar between the auger flighting to urge crop material rearward toward the conditioning rolls 54. The fluting 146 is in the form of bars having a diameter of about 0.5 inches welded to the outer surface 18 of the lean bar 34.

The lean bar 35 and its associated crop urging elements may be arranged so as to provide crop material 10 to the header in a desired orientation for optimum feeding to the next element of the header 32, such as having the length of the crop material stalk perpendicular to the cutterbar, or parallel to the direction of header travel. The crop material provided to the header 32 may be processed by the header 32 and discharged through a rear opening 104 (FIG. 4A) and guided by guide plates 106 into a windrow or swath.

Whereas in the example embodiments discussed above the lean bar 34 may be arranged for free rotation and rotated by contact with crop material the rotation of the lean bar 34 could be driven powered. For example, in the embodiment shown in FIGS. 4B, 4C, and 6, a hydraulic motor 112 may be mounted on a positioning arm 82 and powered by a hydraulic line 114 extending from the vehicle 2. The motor 112 may be driven by movement of fluid within the hydraulic line 114 by a pump or other fluid source as known to one of ordinary skill in the art. In the example embodiment shown, the motor 112 may be coupled to a first pulley 122 mounted on a positioning arm 82. The first pulley 122 may be coupled to a second pulley 124 by a drive belt 132 and the second pulley 124 coupled to a shaft 84 of the lean bar 34 journaled in the bearing assembly 92. Through this arrangement, operation of the motor 112 results in the rotation of the lean bar 34. While in the example embodiments a hydraulic motor 112 is used to power the rotation of the lean bar 34, other means could be used, such as an electric drive or a mechanical arrangement coupled to the header drive (not shown) housed within the header motor housing 64.

In an example embodiment, the drive means may be a reversible variable speed drive, such as a variable speed hydraulic motor 112 for varying the rotational speed and direction of the lean bar 34. For example a Gerotor motor from Eaton may be used that allows for the speed of the drive to be varied by manipulating the flow of hydraulic fluid through the motor as known to one of skill in the art. The speed of rotation of the lean bar 34 may be controlled in accordance with a predetermined scheme. For example, the lean bar rotational speed may be varied in response to the speed of the vehicle 2 or the speed of the cutters 52 of the header 24. As discussed in more detail below, a controller 154 may be used to control the rotational speed of the lean bar 34 and such rotation may be performed in a variety of modes, with varying degrees of control by an operator, such as a manual mode, an automatic mode, a semi-automatic mode, etc. For example, a user interface, such as a control panel 156, may be provided in the cab 20 of the vehicle 2 and include switches or other user input means by which an operator can control the rotational speed of the lean bar 34.

As perhaps best shown in FIG. 6, the position of the lean bar 34 is adjustable. In one example embodiment, an adjustable arrangement comprises a positioning arm 82 and a header pin slot/pin hole arrangement that allows for the translational and rotational movement of the positioning arm 82 with respect to the header 24 to allow the lean bar 34 to be placed in a desired position. In the example embodiment, the positioning arms 82 include a pin receiving slot 162 and a pin receiving hole 164. A mount in the form of a flange 172 is provided at the header frame 174 and includes a second pin receiving slot 182 and a plurality of pin receiving holes 184 that work in conjunction with the slot 162 and hole 164 of the positioning arms 82. The pin slots 162, 182 and pin holes 164, 184 may be configured to releasably receive a removable pin. The pin may be releasably locked to hold the positioning arms 82 in a desired position to hold the lean bar 34 in a desired position relative to the header 26.

The pin receiving hole 164 in the positioning arm 82 corresponds with the slot 182 in the mount 172. A pin may be inserted through the pin receiving hole 164 and the slot 182 to allow translational movement along the slot as well as the rotation of the positioning arm 82 about the pin which acts as a pivot point. The pin slots 162 provided in the positioning arm 182 cooperate with the pin receiving holes 184 in the mount 172 to allow for the positioning arm 82 to be positioned such that the pin receiving slot 162 is aligned with one of the pin receiving holes 184. A pin may be inserted therethrough to hold the positioning arm at the desired position. Thus, an operator may change the position of the lean bar 34 by removing pins from the pin holes 164, 184 and slots 162, 164 arrange the position of the lean bar 34 as desired and re-insert the pins to hold the lean bar 34 at the desired position. The pins used may be configured to releasably hold the positioning arm 82 in the desired position to allow for repeated easy adjustment of the lean bar 34 position. Once a desired position of the lean bar 34 is obtained, the operator may lock the pins in order to hold the lean bar 34 in the desired position.

In the example embodiment shown in FIG. 6A the positioning arms 82 are configured so that the pin holes 164, 184 are arranged to correspond with the pin slots 162, 184 respectively so that a pin may be inserted through a pin slot 162, 182 and a corresponding pin hole 164, 184. In this arrangement, the pins may be moved along the slots 162, 182 to allow translational movement of the positioning arms 81 as shown by arrows A in FIG. 6A. This arrangement also allows the pin inserted through the pin hole 164 in the positioning arm 82 and the slot 182 in the flange 172 to serve as a pivot point about which the positioning arms may be rotated as shown by arrow B.

This rotation allows the receiving slot 162 of the positioning arm 82 to be moved for alignment with one of the pin receiving holes 184 in the mount 172 to a desired inclination. The positioning arm 82 may also slide along the path created by the slot 162. Once the positioning arms 82 are in a desired position, the arms 82 may be locked in place by locking the pins. For example, the pin may comprise hardware that may be tightened down on the positioning arm 82 and the mount 172. In one example embodiment a bolt and nut may be used. This arrangement allows for the easy adjustment of the position of the lean bar 34.

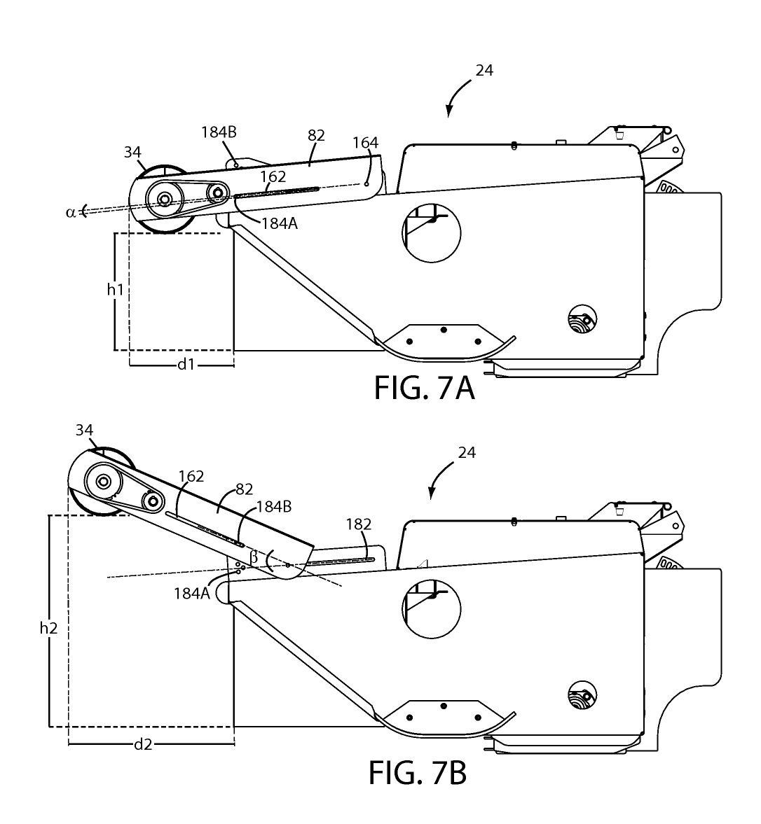

As shown in FIG. 7A the positioning arms 82 are positioned in a first position P1 wherein the positioning arms 82 are retracted along the slots 162, 182 and rotated about the pivot point 164 to a first angle α with respect to the slot 182. The slot 162 in the positioning arm 82 is aligned with a lower pin hole 184 so that the lean bar 34 is forward of the header 32 by a distance d1 and a height h1 above the cutting bed 44. This arrangement may be preferable for knocking down and processing a shorter crop, such as native grass. Pins may be inserted through the pin holes 164, 184 and pin slots 162, 164 and locked to keep the lean bar 34 in position.

In the event a different crop is to be processed, such as forage sorghum, then it may be desirable to adjust the position of the lean bar 34. In that case, the pins may be unlocked and the lean bar repositioned to a position P2 shown in FIG. 6B in which the lean bar 34 is positioned at a distance d2 forward of the header 26 and a height h2 above the cutting bed 44 and higher than a conditioning roll 54 of the header 26. In this position, the pin slot 162 is aligned with an upper pin receiving hole 184B and the position arm is rotated at an angle β. Once in the desired position, the pins may then be locked into place. To reposition the lean bar a user can simply remove the pin and reposition the positioning arms 24. This arrangement may be preferable for taller crops such as forage sorghum.

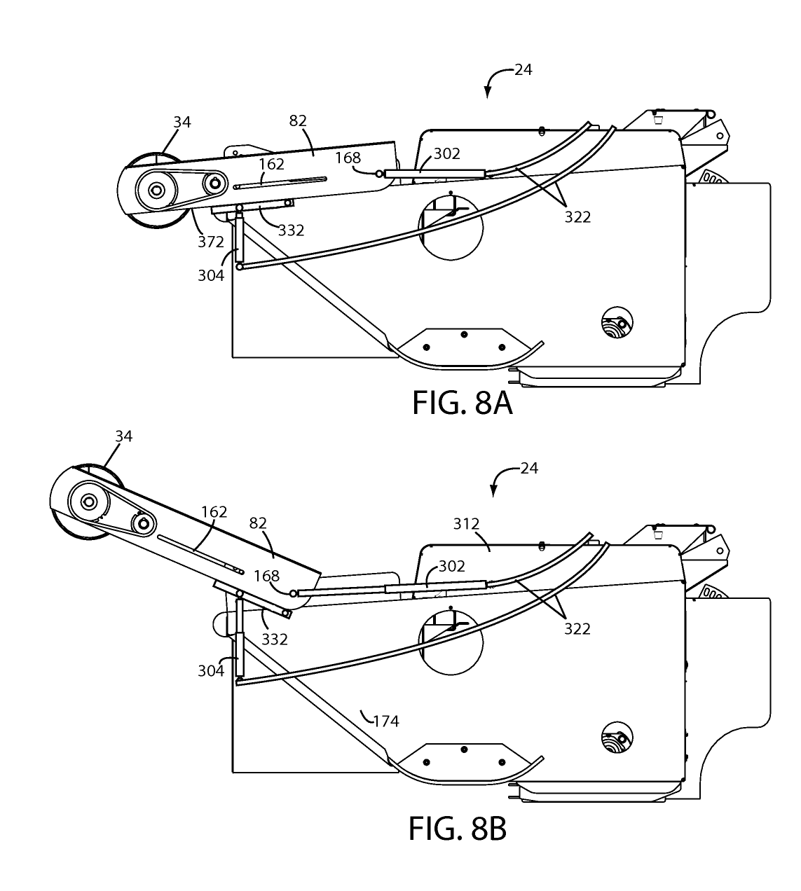

In addition to manual adjustment of the lean bar, a powered adjustable configuration is also contemplated. For example, as shown in FIGS. 8A and 8B, first 302 and second 304 hydraulic cylinders may be provided for moving the positioning arms 24 relative to the header 32. The first cylinder 302 may be affixed at one end to a plate 312 of the header frame 174 and the opposing end affixed to a pin 168 extending through the pin hole 164 of the positioning aim 82 and the pin receiving slot 182 of the flange 172. The cylinder 302 could be powered by the agricultural vehicle 10 via a hydraulic line 322 to move the positioning aim 82 along the slot 182 by the extension and retraction of the cylinder 302.

A second hydraulic cylinder 304 may be coupled to a rotatable angle guide 332 configured for rotation about a rotation point 342. A first end of the cylinder 302 may be attached to the header frame 174 and a second end to the angle guide 332 such that extension and retraction of the cylinder 304 rotates the angle guide 332 to rotate the angle guide 332 about the pivot point 168 to change the position of the lean bar 34. Thus, in a first position shown in FIG. 8A the first 302 and second 304 cylinders are in a retracted condition and the lean bar 34 is in a first position similar to the shown in FIG. 7A. In FIG. 8B the cylinders 302, 304 are in an extended condition to raise the lean bar 34 and extend it further forward to a position similar to that shown in FIG. 7B. The actuation of the cylinders 302, 304 may be controlled by a controller or directly by an operator of the vehicle 2 as explained in more detail below. This powered adjustment could also be accomplished with an electric linear actuator in lieu of a hydraulic cylinder.

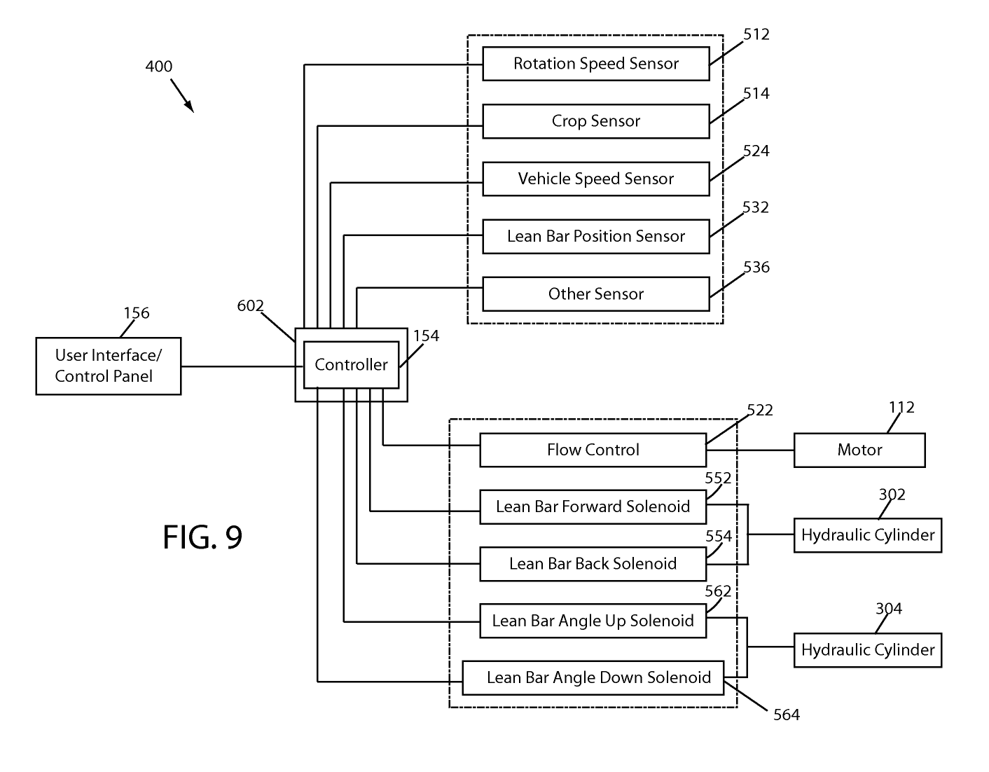

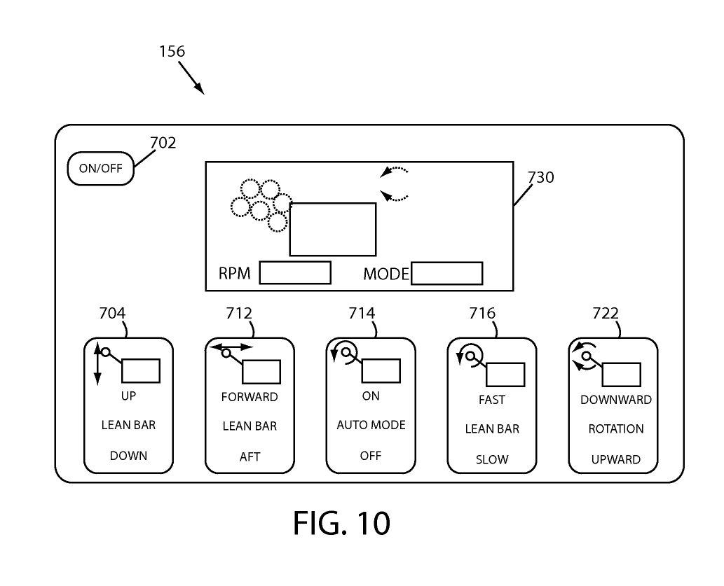

As mentioned above, the rotation of the lean bar 34 and the position of the lean bar may be manipulated. FIG. 9 shows an example embodiment of a lean bar control system 400. The control system 400 may include a controller 154 positioned on or near the lean bar 34 and a user interface 500 (FIG. 10) positioned on the vehicle 2, such as a tractor or combine used in conjunction with the header assembly 24. The controller 154 may receive data from one or more sensors and in response issue commands to effect various operations of the lean bar 34, such as its position and rotational characteristics. Although the controller 154 and the user interface 500 are shown as separate components, their functions could also be combined into a single unit positioned on the header assembly 24 or the vehicle 2. The lean bar controller 154 may be used to control the operation of the lean bar 34, including its various operational modes. For example, a speed sensor 512 (shown schematically), such as a magnetic pickup may deteimine the rotational speed of the lean bar 34 and provide a corresponding signal to the controller 154 and the user interface 500. A crop sensor, such as an ultrasonic sensor may be used to determine a characteristic of the crop material 10, such as the height of the crop material, and provide a corresponding signal to the controller 154 to determine the desired height of the lean bar 34.

As discussed above, rotation of the lean bar 34 may be driven by a pulley 122 whose rotation results in the rotation of the lean bar 34 by the belt drive 132 and second pulley 124. The pulley arrangement may be powered by the hydraulic motor 112 mounted on the positioning arm 82. For example, fluid may be provided to the hydraulic motor 112 from a hydraulic pump (not shown) by the hydraulic line 114 and the flow of fluid manipulated by solenoids and/or flow control valves to vary the fluid flow to manipulate the speed and/or direction of rotation of the motor 112 and hence the lean bar 34. This arrangement thus allows the rotation of the lean bar 34 to be controlled by the controller 154.

In an example embodiment, a flow control valve 522 (shown schematically in FIG. 9) may be communicatively coupled to the controller 154 and used to control the hydraulic motor 112 and thus the rotational movement of the lean bar 34. The controller 154 may also manipulate other components of the lean bar assembly 36 such as adjusting the position of the lean bar as discussed below. It should be noted that while a single controller 154 is shown as controlling both the rotation and the positioning of the lean bar 34 multiple controllers could be used to accomplish the same tasks.

As discussed in more detail below, the lean bar 34 may be manipulated by the controller 154 in accordance with predetermined schemes programmed by an operator. For example, the rotation of the lean bar 34 may be manipulated in response to the speed of the vehicle 2. For example, the speed of the vehicle 2 may be determined by a vehicle speed sensor 524, such as a speedometer of the vehicle 2, to the controller 154. As the vehicle speed increases, the controller 154 may increase the rotational speed of the lean bar 35 to assist in processing the expected increase in crop material 10 to be processed. This allows header assembly 24 to automatically adjust its rotational speed.

Various other sensors 536 could be used by the controller 154 to manipulate the rotation of the lean bar 34. For example, a sensor could be used to monitor the speed of the cutters of the cutting bed and this information used to adjust the rotation of the lean bar 34.

FIG. 9 is a schematic drawing of an embodiment of an electronic control system 400 of the header assembly 24 of FIG. 1. The system 400 comprises a system box 602 containing a controller 154 and associated electronic components whose construct will be understood by one of ordinary skill but the details of which are unimportant to the present invention. The arrangement may be comprised of hardware, software, firmware or combination thereof as would be apparent to one of skill in the art. For example, the controller 154 may be a microcontroller capable of receiving data and issuing commands for the control of various systems and components in accordance with particular schemes that may be programmed in the microcontroller.

The system box 502 and controller 154 are connected to elements controlled by the controller 154 that are distributed about the header assembly 24 and the vehicle 2. Although single lines are depicted running from the system box to the various elements, these lines may represent multiple wired connections that are connected to the indicated elements.

The system box 602 and controller 70 are connected to different sensors including the lean bar speed sensor 512, the vehicle speed sensor 522, a lean bar position sensor 524 and a crop height sensor 514. The lean bar speed sensor 512 sends a signal to the controller 154 indicating the rotational speed of the lean bar, the vehicle speed sensor 522 sends a signal to the controller 154 indicating the vehicle speed, the lean bar position sensor 524 sends a signal to the controller indicating the position of the lean bar 34 relative to the header 32, and the crop height sensor sends a signal to the controller 154 indicated the height of the crop material 10 forward of the lean bar 34.

The system box 602 and controller 154 are also connected to different elements to control the rotation and position of the lean bar 34, such as solenoids and valves that activate the flow of hydraulic fluid to different systems of the lean bar assembly 36 and the control panel 156 for effectuating desired commands of an operator. For example, in the example embodiment shown in FIG. 9, the controller 154 is connected to the flow control valve 522 which can be used to control the flow of fluid to the motor 112 and thereby manipulate the rotation of the lean bar 34. The controller 154 may also be connected to a lean bar forward solenoid 552 and lean bar rearward solenoid 554 for use in manipulating the hydraulic cylinder 302 to extend and retract and thereby provide for the forward and rearward translational movement of the lean bar 34 with respect to the header 32. Similarly, the controller 154 may be connected to a lean bar angle up solenoid 562 and lean bar angle down solenoid 564 in order to manipulated the hydraulic cylinder 304 coupled to the angle guide 332 and provide for the rotational movement of the positioning arm 82 to position the lean bar 34.

The system box 602 and controller 154 may also be connected to the control panel 156 so that an operator may issue commands to the controller. In an example embodiment, the control panel 156 may be located in the cab 14 of the vehicle 2 and include input means for use by the operator.

FIG. 10 shows a plan view of a user interface 500 in the form of a control console 500 provided at an operator's station, such as in the cab of the towing vehicle 2, such as that of a tractor pushing the header assembly 24 through the field, that is accessible by the operator when operating the header assembly 24. The control console 500 may be configured with controls to provide the operator with different levels of control over the lean bar 34. For example, the operator may be provided with full manual control mode, a semi-automatic control mode, or an automatic control mode. In full manual control mode the operator initiates the operation of the lean bar. In the semi-automatic mode, the operator will have less interaction and control fewer tasks. In the full automatic control mode the lean bar may be operated without additional input from the operator.

The example embodiment of the control console 500 of FIG. 10 includes a power on/off button 702, a lean bar up/down 704, a lean bar forward/back button 712, a program mode set button 714, a lean bar rotation speed button 716, a lean bar rotation direction button 722. A central display 730 may also be provided that indicates the lean bar status to the operator, such as the speed of rotation, the direction of rotation, and the position of the lean bar 34.

The various buttons may be used by the operator to manipulate the lean bar 34. For example the lean bar up/down button 704 and lean bar forward/aft button 712 may be used to change the position of the lean bar by manipulating the hydraulic cylinders 302, 304, respectively. The lean bar rotation speed button 716 and lean bar rotation direction button 722 may be used to manipulate the motor 112 to manipulate the rotation of the lean bar. The program mode set button 714 may be used to enter various modes of operation of the lean bar 34. For example, in a manual mode the operator may use the various buttons 704, 712, 716, 722 to directly manipulate the lean bar 34. If an automatic mode is selected, then the controller 154 may manipulate the lean bar 34 in accordance with a predetermined scheme. For example, a scheme may include operating the rotational speed of the lean bar at a steady speed or in response to the speed of the vehicle. A scheme may also include positioning the lean bar at a particular position in response to the height of the crop material 10 detected by a crop height sensor 514 such as placing the lean bar 30 inches below the detected height of the crop material 10.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A header assembly, comprising:
a header;
a rotatable lean bar; and
a variable speed power source configured to rotate the rotatable lean bar in accordance with a predetermined scheme.

2. The header assembly of claim 1, wherein the variable speed power source comprises a hydraulic motor.

3. The header assembly of claim 1, wherein the rotational speed of the lean bar is controllable remotely by an operator.

4. The header assembly of claim 1, wherein the rotational direction of the lean bar is controllable remotely by an operator.

5. The header assembly of claim 1, further comprising:
a controller configured to manipulate the rotation of the rotatable lean bar.

6. The header assembly of claim 5, wherein the controller is configured to manipulate speed of rotation of the rotatable lean bar.

7. The header assembly of claim 5, wherein the controller is configured to manipulated direction of rotation of the rotatable lean bar.

8. The header assembly of claim 1, further comprising a control panel configured to allow an operator to manipulate rotation speed of the rotatable lean bar.

9. The header assembly of claim 5, wherein said controller is configured to manipulate rotation of the lean bar in response to a characteristic of a vehicle.

10. The header assembly of claim 9, wherein said characteristic is a vehicle speed.

11. The header assembly of claim 5, wherein said controller is configured to manipulate rotation of the rotatable lean bar in response to a user input.

12. The header assembly of claim 5, further comprising a sensor to detect a rotational characteristic of the rotatable lean bar.

13. The header assembly of claim 5, further comprising a display configured to indicate a rotational characteristic of the rotatable lean bar.

14. The header assembly of claim 1, wherein said rotatable lean bar is rotatable in a first direction and a second direction.

15. An apparatus, comprising:
a header;
a rotatable lean bar; and
a controller configured to manipulate rotation of the lean bar.

16. The apparatus of claim 15, wherein the controller is configured to manipulate rotational speed of the rotatable lean bar.

17. The apparatus of claim 15, wherein the controller is configured to manipulate a rotational direction of the rotatable lean bar.

18. The apparatus of claim 15, wherein the controller is configured to manipulate rotation of the rotatable lean bar in response to a characteristic of the vehicle.

19. The apparatus of claim 18, wherein the characteristic of the vehicle is a vehicle speed.

20. The apparatus of claim 17, further comprising a control panel configured to receive a user input.

21. The apparatus of claim 20, further comprising:
a cab, wherein the control panel is located in the cab.

22. An apparatus, comprising:
a rotatable lean bar configured for connection with a header; and
a sensor configured to detect a characteristic of the rotatable lean bar.

23. The apparatus of claim 22, wherein the sensor is configured to detect a rotational characteristic of the rotatable lean bar.

24. The apparatus of claim 23, wherein the rotational characteristic is rotational speed.

25. The apparatus of claim 22, wherein the rotational characteristic is rotational direction.

26. The apparatus of claim 22, further comprising a display configured to indicate a characteristic of the rotatable lean bar.

27. The apparatus of claim 26, wherein the characteristic of the rotatable lean bar is a rotational characteristic.
